(19) United States
(12) Patent Application Publication
(10) Pub. No.: US 2011/0280199 A1
(43) Pub. Date: Nov. 17, 2011

(54) Method and Arrangement in a Telecommunication System

(76) Inventors: Daniel Widell, Vikbolandet (SE); Andreas Bergström, Vikingstad (SE); John Walter Diachina, Garner, NC (US); Paul Schliwa-Bertling, Ljungsbro (SE)

(21) Appl. No.: 13/104,273

(22) Filed: May 10, 2011

Related U.S. Application Data
(60) Provisional application No. 61/333,341, filed on May 11, 2010.

(51) Int. Cl. H04W 74/08

(52) U.S. Cl. 370/329

(57) ABSTRACT

Pre-existing methods of accessing a radio system via a random access channel as described in 3GPP TS 44.018 “Radio Resource Control (RRC) protocol” is modified to include a first additional parameter (i), which defines the spreading of the probability density function for each successive access attempt. In accordance with one embodiment the accessing user/device is configured to use a random wait time for the j-th retry to access the RACH as a function of the additional parameter (i) and the number j, where j is a positive integer.

### RELATED APPLICATIONS

This application claims priority under 35 U.S.C. 119(e) to U.S. Provisional Patent Application No. 61/333,341, which was filed May 11, 2010 and is incorporated by reference herein in its entirety.

### TECHNICAL FIELD

The present invention relates to methods and devices in a telecommunication system, in particular to a method and arrangement access strategies for minimizing Random Access Channel (RACH) congestion.

### BACKGROUND

So far, the traffic generated in mobile networks such as e.g. GSM/EDGE Radio Access Network (GERAN) and UTMS Radio Access Network (UTRAN) has mostly been dominated by services that require human interaction, such as e.g. regular speech calls, web-surfing, sending Multi Media Service (MMS) messages, doing video-chats etc. The same traffic pattern is also anticipated for Evolved UTMS Radio Access Network (E-UTRAN).

There is however increasing traffic related to Machine Type Communication (MTC) services, which do not necessarily need human interaction. The requirements these services place on the serving network will typically differ from what is provided by today's mobile networks, as is outlined in 3GPP TS 22.368 “Service requirements for machine-type communications”.

For mobile networks such as GERAN to be competitive for mass market MTC applications and devices, it is important to optimize their support for machine-type communications.

When an Evolved General Packet Radio Service (EGPRS) capable mobile station wants to request resources in a GERAN network it will do so on the Random Access Channel (RACH) according to a procedure defined in 3GPP TS 44.018 “Radio Resource Control (RRC) protocol”. This RACH channel may in certain situations be overloaded, whereupon measures must be taken in order not to overload the RACH thereby possibly making any new connection such as even e.g. a regular voice call setup impossible.

Existing methods for avoiding overload are sometimes inefficient. This is especially true in the context of machine-type communications.

Also other systems than GERAN having a collision based access channel, such as e.g. any 3GPP or 3GPP2 network, WiFi, etc, can experience the same problems.

When an EGPRS capable mobile station wants to request resources in a GERAN network it will do so by e.g. sending an EGPRS PACKET CHANNEL REQUEST on the Random Access Channel (RACH). This RACH channel operates within a Time Division Multiple Access (TDMA) frame structure consisting of approximately 217 TDMA frames (also referred to as RACH slots) per second. These access attempts sent on the RACH are not explicitly scheduled by the network, but rather a collision-based approach is used according to a procedure as described in 3GPP TS 44.018 “Radio Resource Control (RRC) protocol”.

The RACH channel can thus be described as a so-called Slotted Aloha channel, for which the accessing users/devices apply a re-attempt strategy (in case the first access attempt fails) which includes a pseudo-random waiting time used to determine when a new access attempt can be made. This waiting time shall be randomly drawn from a uniform distribution defined by system parameters which are broadcasted on the Broadcast Control Channel (BCCH) in the cell, and is currently the same for all Packet Switched (PS) related access attempts by all users/devices in the cell. These parameters consist of a minimum waiting time which is a number of S TDMA frames, and a width of the uniform distribution of the pseudo-stochastic part of the waiting time which is a time T of TDMA frames. Also, there is a parameter M which defines the maximum total number of access attempts that shall be performed by each user/device before aborting the access procedure.

Thus, given these parameters S and T, let the discrete stochastic variable X denote the time a user has to wait after an failed access attempt (an access attempt will here be considered failed if two or more users/devices try to access the same RACH slot) before making a new access attempt. The probability density function for X can be described as depicted in FIG. 1, and given by:

$${p}_{X} [ x ] = \{ \begin{matrix}\frac{1}{T} & S \leq x < S + T \\ 0 & otherwise .\end{matrix}$$

The problem arises when there are many devices trying to access the RACH channel simultaneously. Normally this is not a problem, as there are approximately 217 RACH frames per second and with human controlled devices a reasonable assumption to make is that the RACH access attempts are not synchronized between the various users/devices. Thus, in these situations, the capacity of the RACH becomes more of a dimensioning issue since it is possible to have up to 4 RACH channels in one cell.

However a problem can arise if many synchronized devices, e.g. electricity meters from power-companies that upload the electricity consumption once a day at a given time, try to make an access to the system via the RACH simultaneously. Even if these access attempts are not individually synchronized to a 5 ms level, the sheer amount of devices will result in a substantial amount of synchronized access attempts.

Having a retry scheme where the users wait a random period of time, where the randomness as per the existing solution in 3GPP TS 44.018 “Radio Resource Control (RRC) protocol is picked from a uniform distribution, will therefore provide problems when there is a large “spike” in the number of users trying to access the RACH at the same time. The risk is quite large in these situations that the users/devices which collided at the initial access attempt will also continue colliding at any subsequent access attempt. This in turn may cause “outage periods” where the RACH, and thus the whole system, is totally inaccessible with a periodicity approximately corresponding to the broadcasted parameter S.

The behavior described above is described in 3GPP TS 44.018 “Radio Resource Control (RRC) protocol”, when the device is requesting resources for a Packet Switched (PS) connection other than in the case of sending a paging response. In all other cases, such as e.g. when the device is requesting resources for a CS connection or for a PS connection in response to a paging message, then already the first initial access attempt on the RACH shall be randomly distributed according to the herein described procedure but with S having the value 0 for this first attempt.

Thus, the principal behavior for this case will still be exactly the same if applied to the traffic situation of an access “spike” as considered here, but with the difference being that what is herein described as retransmission number j rather shall be seen as transmission number j or retransmission number j−1.

Assume that there are in total K=kT,kεN⁺ (k is a positive integer) users attempting to access simultaneously on one and the same RACH slot. For the sake of simplicity it is assumed that the total number of users is a multiple of T such that k is a positive integer. Thus the access attempts by these users can be described as a unit impulse in time, a[n]=Kδ[n] with amplitude K.

Let h^{(j)} describe how the users are distributed in time at the j-th retransmission attempt. After the first retransmission event:

$${h}^{( 1 )} [ n ] = a * {p}_{X} [ n ] = \{ \begin{matrix}\frac{K}{T} = k & S \leq n < S + T \\ 0 & otherwise .\end{matrix}$$

FIG. 2 depicts the distribution of users at the first retransmission attempt.

Clearly, if k>1 more than one user/device will try to access each RACH slot in the interval [S, S+T−1], and as a consequence no users/devices will be served due to the collisions that thereby will occur. For T or fewer users this will not be a problem as all users will be served (given that they are evenly distributed).

If, on the other hand, k>1 then another access attempt will occur. After this second access attempt event the users are distributed according to:

$${h}^{( 2 )} [ n ] = {h}^{( 1 )} * {p}_{X} [ n ] = \{ \begin{matrix}\frac{k}{T} ( n - 2 S ) + \frac{k}{T} & 2 S \leq n < 2 S + T \\ k - \frac{k}{T} ( n - ( 2 S + T - 1 ) ) & 2 S + T \leq n < 2 S + 2 T - 1 \\ 0 & otherwise\end{matrix}$$

FIG. 3 depicts how the users are distributed after the second access attempt.

Since k>1 all users can not be served (as the peak of the distribution is k). If k>T, then obviously no users will be served. This corresponds to that the total amount of users is

K>T². (1)

Now, assuming that (1) is fulfilled, there will be a third access attempt. From this point on no exact distributions of the users will be given for the sake of simplicity. Instead a lower bound on the number of users that can be served is provided. That is, the minimum number of users which will be served after the j-th access attempt.

After the third access attempt the users will now be distributed according to:

h⁽³⁾[n]=h⁽²⁾*p_{X}[n]

In FIG. 4 the distribution after third access attempt is illustrated.

Although possible, no exact expressions for the distribution h⁽³⁾[n] are provided here. Instead, an upper bound is provided.

First, in this case only odd values T are considered, but a similar bound can be provided for even T. It shall further also be noted that the value of MaxP depends on whether T is even or odd as per:

$$MaxP = \{ \begin{matrix}\frac{3 ( T - 1 )}{2} & for T odd \\ [ \frac{3 ( T - 1 ) - 1}{2} , \frac{3 ( T - 1 ) + 1}{2} ] & for T even\end{matrix}$$

where the even case includes that there are two maximum values of h⁽³⁾[n].

The peak value of the distribution is MaxA<k Note that this inequality will not be tight if inequality (1) does not hold. Instead it is possible to approximate how many users that will not be served in the situation depicted in FIG. 3. A rough estimation can be done by assuming that the distribution is a continuous function and thereafter calculate the integral in the interval where h⁽²⁾[n]>1, denote this area A_{CA}, and compare it to the total integral, A_{T}. In this manner the percentage of users that will not be served at the second access attempt can then be approximated by:

$$\frac{{K}_{R 2}}{K} = \frac{{A}_{CA}}{{A}_{T}} = \frac{T ( k - \frac{1}{k} )}{k ( T - \frac{1}{T} )} ,$$

where K_{R2} denotes the number of users not served by the second access attempt event. MaxA can then be approximated as:

$$MaxA \approx \{ \begin{matrix}k & if \frac{k}{T} > 1 \\ k \frac{{A}_{CA}}{{A}_{T}} & otherwise .\end{matrix}$$

It should be noted that the left and right limits of the distribution h⁽³⁾[n]] in FIG. 4 are affected if k/T≦1, but as the aim is to only provide an upper bound it is assumed the bounds left and right limit are kept intact as depicted in FIG. 4.

Further, let the number of users/devices which still has not been served after the third access attempt be denoted K_{R3}. If after the third access attempt k/T²>1 still no users have been served, then K_{R3}=K. On the other hand, if k/T²≦1, then the upper bound can still be used to approximate how many users will not get served out of the total number of users using simple summation.

$${K}_{R 3} \leq 2 {\sum }_{x = ⌊ {x}_{low} ⌋ + 1}^{MaxP - 1} ( \frac{2}{3} \frac{( MaxA - k / {T}^{2} )}{( T - 1 )} x + \frac{k}{{T}^{2}} ) + MaxA , odd case , \\ and$$

$${K}_{R 3} \leq 2 {\sum }_{x = ⌊ {x}_{low} ⌋ + 1}^{{MaxP}_{low}} ( 2 \frac{( MaxA - k / {T}^{2} )}{( 3 T - 4 )} x + \frac{k}{T} ) , even case . \\ where$$

$${x}_{low} = \{ \begin{matrix}( 1 - \frac{k}{{T}^{2}} ) \frac{3}{2} \frac{( T - 1 )}{( MaxA - k / {T}^{2} )} & for T odd \\ ( 1 - \frac{k}{{T}^{2}} ) \frac{1}{2} \frac{( 3 M - 4 )}{( MaxA - k / {T}^{2} )} & for T even\end{matrix}$$

Similar approach can be made for access attempt event 4, R4, where MaxA can be approximated by.

$$MaxA \approx \{ \begin{matrix}k & if \frac{k}{{T}^{2}} > 1 \\ k \frac{{K}_{R 3}}{{K}_{R 2}} & otherwise\end{matrix}$$

Assume that access attempt event R4 is the last access attempt event, as determined by the parameter M broadcasted on the Broadcast Control Channel (BCCH). It then becomes critical that MaxA is smaller than k, otherwise all users will not be served. Thus, it is desired to avoid the situation where:

$$\frac{k}{{T}^{2}} > 1.$$

Further, it is desired to serve all users so that they don't occupy future system resources. It is therefore desired that for all users to be served that

$$k \frac{{K}_{R 3}}{{K}_{R 2}} < 1 is fulfilled .$$

To further illustrate this behavior, the probabilistic behavior over time is shown in FIG. 5 for the case when 100, 300 and 1000 users attempt to access the system via the RACH when T=50, S=55 and M=4. FIG. 5 shows the probabilistic behaviour over times using the existing procedure defined in 3GPP TS 44.018 “Radio Resource Control (RRC) protocol” for the simultaneous access attempts of 100 users (left), 300 users (middle) and 1000 users (right) when T=50, S=55 and M=4. FIG. 5 shows the expected number access attempts per RACH slot when all performing the first access attempt at air frame number 0. Every time the values in the graph exceeds the value 1 (as marked in FIG. 5) there are in average more than one access attempt per RACH slot, whereupon the RACH and thus the cell will in practice be inaccessible during these instances.

After the first waiting period (55-1 TDMA frames) as much as 362 TDMA frames are needed before all access attempts are successful or the corresponding user has aborted the access procedure after reaching the maximum 4 access attempts. For the case of 100 users. 237/362≈65% of the RACH slots experience collisions. The corresponding values for the 300 user case is 300/362≈83% and for the 1000 user case 323/362≈89%.

The effective utilization of the RACH is thus very poor during this time and, perhaps more importantly, the RACH and thus any access to the cell is unavailable throughout the entire time, 362 TDMA frames (≈1.7 seconds).

An estimate of the number of users that will get admitted can be made by summation of the graphs in FIG. 5 over the interval where the expected number of users is less than or equal to one. Thus for 100 users approximately 52 will be admitted, for 300 users approximately 17 will be admitted and for 1000 users approximately 10 users will be admitted.

To conclude, having a retry scheme as defined today in 3GPP TS 44.018 “Radio Resource Control (RRC) protocol” where the users wait a random period of time, and where the randomness is picked from a uniform distribution, will provide problems when there is a large spike in the number of users trying to access the RACH simultaneously. In these situations, the risk is quite large that the users/devices which collided at the initial access attempt will also continue colliding at any subsequent transmission attempt. This will in turn cause outage periods when the RACH, and thus the whole cell or system, is totally inaccessible with a periodicity approximately corresponding to the broadcasted parameter S or even S*M;

Hence there is a need for an improved method of accessing a radio system, and in particular a cellular radio system where access is provided via a random access channel.

### SUMMARY

It is an object of the present invention to provide improved methods and devices to address the problems as outlined above.

This object and others are obtained by the methods and devices as set out in the appended claims.

In accordance with embodiments described herein the existing method of accessing the radio system via the random access channel as described in 3GPP TS 44.018 “Radio Resource Control (RRC) protocol” is modified to include a first additional parameter (i), which defines the spreading of the probability density function for each successive access attempt. In accordance with one embodiment the accessing user/device is configured to use a random wait time for the j-th retry to access the RACH as a function of the additional parameter (i) and the number j, where j is a positive integer.

In accordance with another embodiment a second additional parameter stating if an initial random delay should be applied is introduced. This second additional parameter can be the same parameter already used when the device is requesting resources for a CS connection or for a PS connection in response to a paging message.

In yet another embodiment yet another parameter, a third additional parameter, controlling if the system should aim at maximizing the peak RACH load capacity or at minimizing the access delay for MTC devices is also included.

Thus, in accordance with one embodiment a method in a user equipment for access in a radio network via a collision based access channel is provided. The method comprises waiting a time before accessing the system via the access channel when an access attempt has failed wherein the waiting time for a new access is set in accordance with a distribution defined by system parameters. The method further comprises determining a spreading of the probability density function for the distribution for each successive access attempt based on a first parameter (i) defining said spreading.

In accordance with one embodiment the parameter (i) determines the wait time distribution for each access attempt by modifying the width of the probability density function for the distribution.

In accordance with one embodiment a random wait time is applied by the user equipment for the j-th retry to access the system via the collision based access channel, wherein the random waiting time is a function of the additional parameter (i) and the number j, where j is a positive integer.

In accordance with one embodiment the user equipment is further controlled by a second parameter (u) that determines to prioritize either to maximize peak load capacity of the collision based access channel or to minimize access delay.

In accordance with one embodiment the user equipment is further controlled by a third parameter (r) that specifies if the user equipment is to employ a delay before making a first access attempt via the collision based access channel. The delay employed delay before making a first access attempt via the collision based access channel can be a randomly set delay or a delay that is set deterministically.

In accordance with one embodiment the user equipment is a Machine Type Communication device.

In accordance with one embodiment the collision based access channel is a random access channel.

The additional parameters can be preconfigured in the user equipment or be configured in a central node of the cellular radio network to which the user equipment can connect. The central node can, without limitation be a node such as a radio base station or a radio network controller. When a parameter is configured in a central node the parameter is in accordance with some embodiments distributed to the user equipment over the air interface.

Using the one or more additional parameters when determining how a user/device are configured to access the radio system via the access channel will provide the advantage that a set of wait time distributions applied over more than one access attempt to spread the users approximately uniformly over time is provided, as opposed to the currently used method of accessing the random access channel. This in turn will free up system resources faster and thus increase the availability of the RACH. This could also be described as that the RACH will not be blocked for such long periods of time compared to today's solution when a considerable amount of MTC users/devices arrive simultaneously.

The invention also extends to a user equipment and to a central node such as a radio base station Node B or a radio network controller arranged to perform the above methods. The UE and the central node can be provided with a controller/controller circuitry for performing the above methods. The controller(s) can be implemented using suitable hardware and or software. The hardware can comprise one or many processors that can be arranged to execute software stored in a readable storage media. The processor(s) can be implemented by a single dedicated processor, by a single shared processor, or by a plurality of individual processors, some of which may be shared or distributed. Moreover, a processor or may include, without limitation, digital signal processor (DSP) hardware, ASIC hardware, read only memory (ROM), random access memory (RAM), and/or other storage media.

### BRIEF DESCRIPTION OF THE DRAWINGS

The present invention will now be described in more detail by way of non-limiting examples and with reference to the accompanying drawing, in which:

FIG. 1 is a diagram illustrating a probability density function for X,

FIG. 2 depicts a distribution of users at a first retransmission attempt,

FIG. 3 depicts how users are distributed after a second access attempt,

FIG. 4 illustrates a distribution after a third access attempt,

FIG. 5 illustrates probabilistic behavior over time,

FIG. 6 is a view of a cellular radio system,

FIG. 7 depicts an ideal desired discrete density function,

FIG. 8 depicts an interleaved density function,

FIG. 9 depicts a distribution after a second access attempt,

FIG. 10 depicts a distribution with a given upper bound,

FIG. 11 depicts a distribution of users after a third access attempt event,

FIG. 12 is a flow chart depicting an exemplary random access scheme for an MTC device,

FIG. 13 is schematic view of a UE,

FIG. 14 is schematic view of a central node in a cellular radio system, and

FIG. 15 is a diagram illustrating the expected number access attempts per RACH slot when performing a first access attempt.

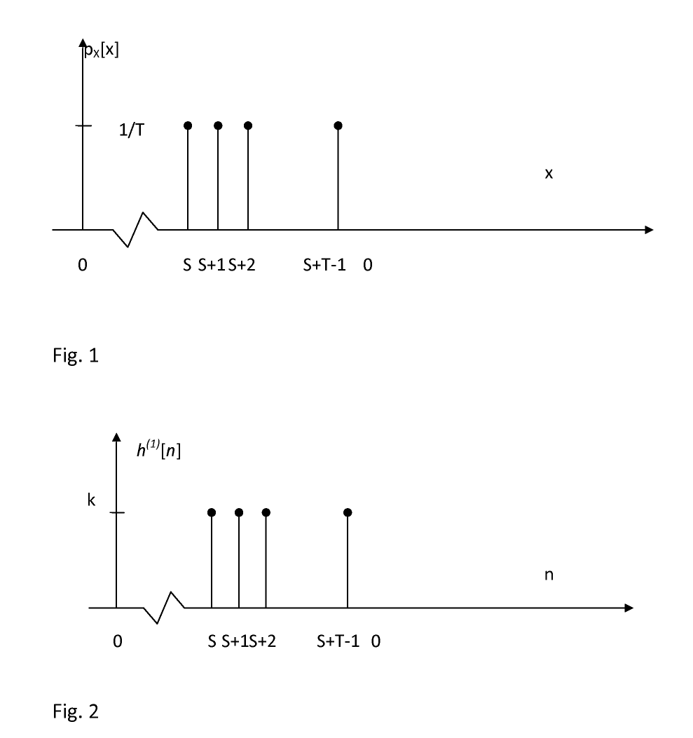

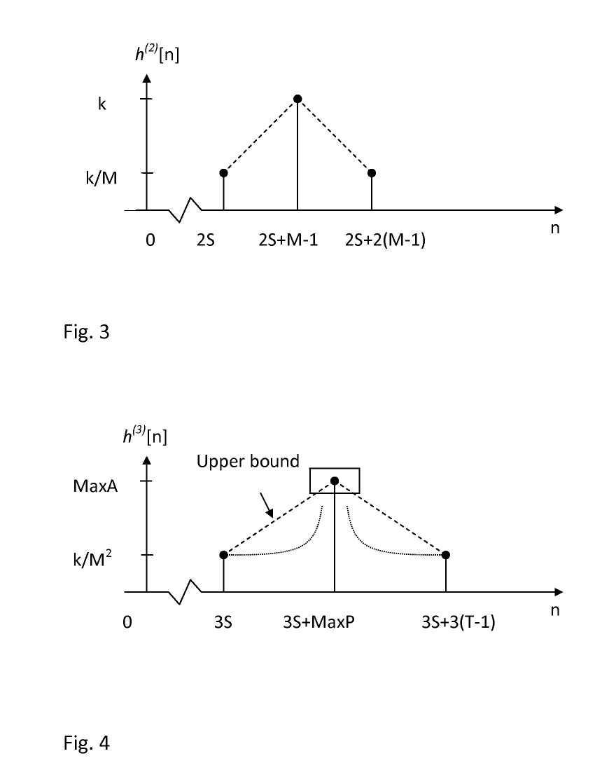

### DETAILED DESCRIPTION

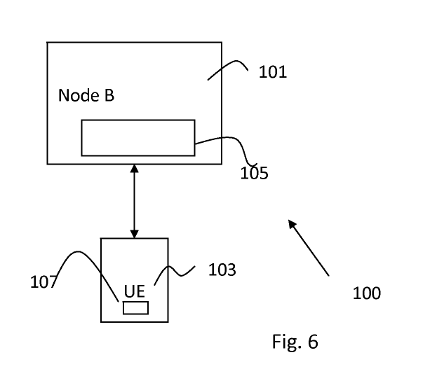

In FIG. 6, a general view of a cellular radio system 100 is depicted. The system 100 depicted in FIG. 6 is a UTRAN system. However it is also envisaged that the system can be a GERAN system or another similar systems. The system 100 comprises a number of radio base stations 101, whereof only one is shown for reasons of simplicity. The radio base station 101 can be connected to by user equipments, which in FIG. 6 are represented by the UE 103 located in the area served by the radio base station 101. The UE access the network via an RACH on the air interface between the UE and the radio base station. The radio base station and the user equipment further comprise controllers/controller circuitry 105 and 107 for providing functionality associated with the respective entities. The controllers 105 and 107 can for example comprise suitable hardware and or software. The hardware can comprise one or many processors that can be arranged to execute software stored in a readable storage media. The processor(s) can be implemented by a single dedicated processor, by a single shared processor, or by a plurality of individual processors, some of which may be shared or distributed. Moreover, a processor may include, without limitation, digital signal processor (DSP) hardware, ASIC hardware, read only memory (ROM), random access memory (RAM), and/or other storage media. The radio base station is further connected to a central control node (not shown) such as a Radio Network Controller provided to control a number of radio base stations.

As described above, let the total number of users/devices trying to access one and the same RACH slot be. K=kT, kεN⁺

As one RACH slot can serve only one user without risking any collisions, then ideally the subsequent access attempts should be spread uniformly, so that after a collision the user waiting time (again being denoted by the stochastic variable X) will be distributed as:

$${p}_{X}^{ideal} [ x ] = \{ \begin{matrix}\frac{1}{K} & S \leq x < S + K \\ 0 & otherwise .\end{matrix}$$

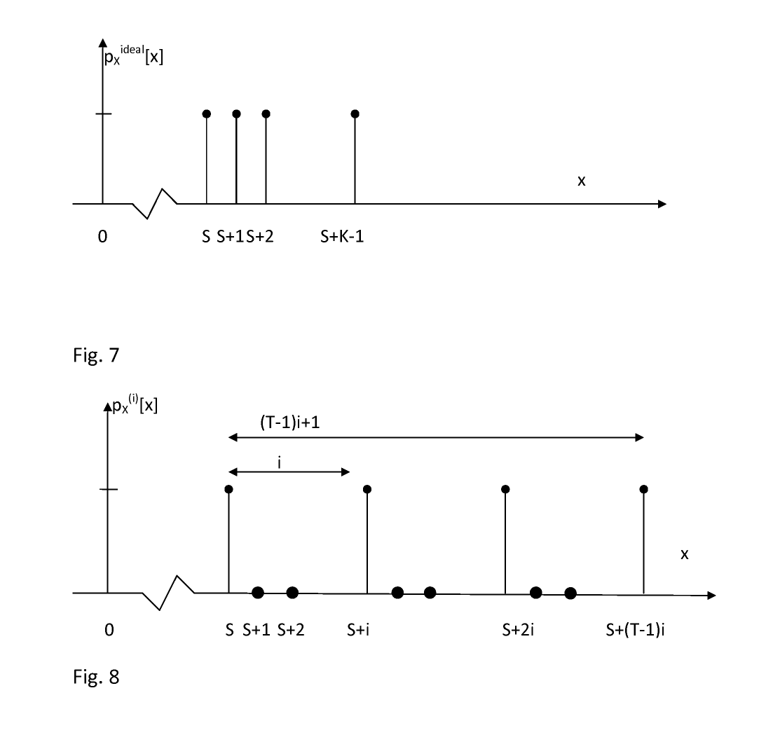

FIG. 7 depicts this ideal desired discrete density function.

For obvious reasons it is not possible to in advance know how many devices that are trying to access one RACH slot simultaneously. An approach that is more likely to succeed is to create a probability density distribution for a pseudo-random wait timer, denote it p_{X}^{i,j} which approximates the ideal distribution after say j access attempts. That is

$$\underbrace{{p}_{X}^{i , 1} * {p}_{X}^{i , 2} * … * {p}_{X}^{i , j} [ x ]}_{j} \approx {p}_{X}^{ideal} [ x ] .$$

Now, let the first access attempt be given, as previously, by p_{X}[x]. Then create an interleaved uniform probability density function consisting of T unit impulses (normalized to amplitude 1/T) separated i in time, that is

$${p}_{X}^{( i )} [ x ] = \frac{1}{T} ( x - ⌊ \frac{x}{i} ⌋ i ) ( u [ x - S ] - u [ x - ( S + ( T - 1 ) i + 1 ) ] )$$

$$i = 1 , 2 , …$$

The interleaved density function is depicted in FIG. 8. The convolution between p_{X}[x] and p_{X}⁽ⁱ⁾[x] can be divided into two different cases, i≧T and i<T.

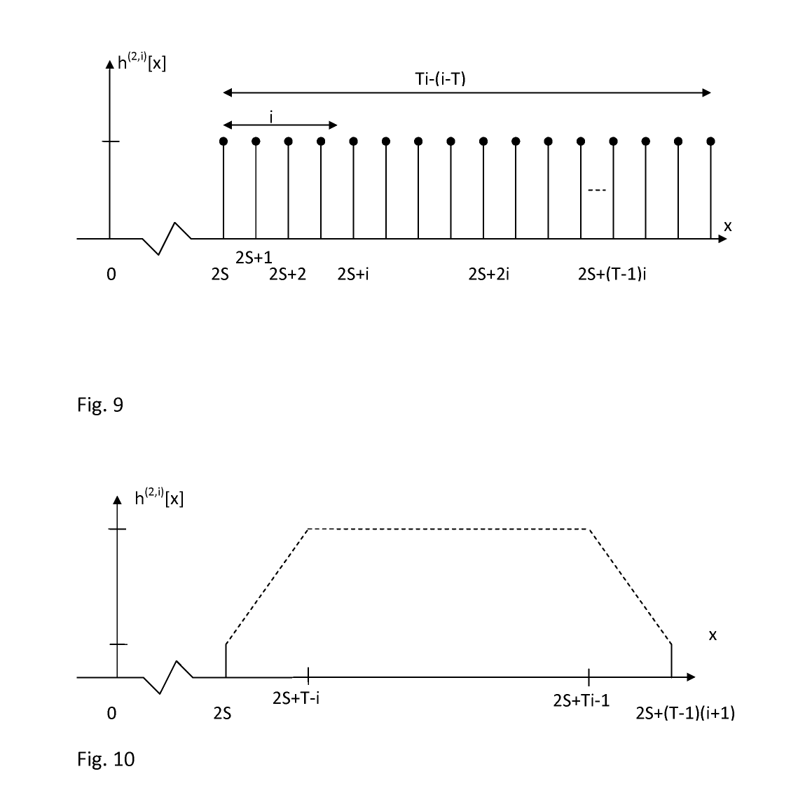

The distribution of K users for i≧T after the second access attempt can be depicted as in FIG. 9. Note that in FIG. 9 the special case i=T is depicted, if i>T there will be (i−T) zeros after each consecutive T impulses.

The distribution of K users for i<T can be given an upper bound as depicted in FIG. 10. It is here to be noted that the left limit of where MaxA first is obtained in FIG. 10 is given by

$$2 S + i ⌊ \frac{T}{i} ⌋ \geq 2 S + i \frac{T - 1}{i} ,$$

which provides an upper bound on the distribution is obtained. It is also to be noted that the right limit of where MaxA last is obtained can in a similar way be upper bounded by 2S+(T−1)i+(i−1)=Ti−1.

Otherwise, the MaxA value can be approximated by

$$MaxA = \frac{k}{T} ⌈ \frac{T}{i} ⌉ \approx \frac{k}{i} .$$

Thus compared to the existing solution described in the background section it is now possible to avoid any further collisions after the second access attempt if

$$\frac{k}{i} \leq 1 ⇔ k \leq i ,$$

where i is a design parameter, which in accordance with some embodiments can be broadcasted as a system parameter for example on the BCCH. The parameter i can also be pre-programmed in an MTC device. The parameter i thus determines how the width of the probability density function for the wait time distribution for each access attempt.

The density distribution function h(2,i)[x] can be upper bounded by the box function with amplitude MaxA and length ((T−1)i+T). Let

$$MaxA = \{ \begin{matrix}\frac{k}{T} & i \geq T \\ \frac{k}{i} & i < T .\end{matrix}$$

The case i>T is of less interest because then the delay is increased without increasing the number of users that can be served. Assume therefore that i≦T and thus that

$$MaxA = \frac{k}{i} .$$

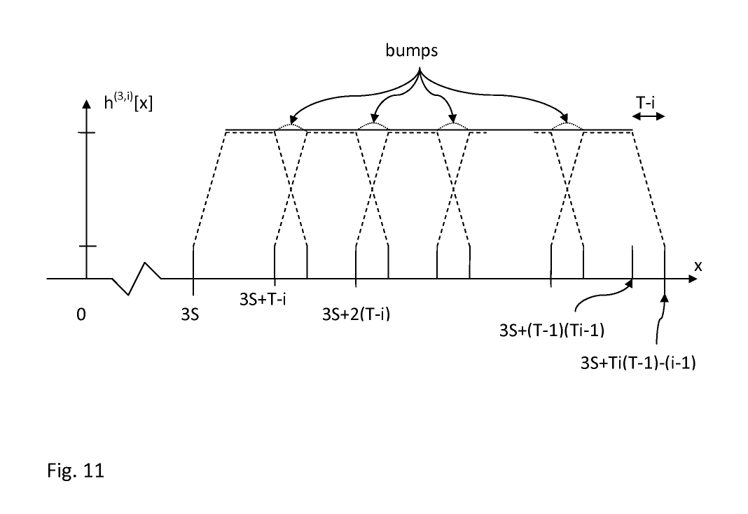

In the situation where MaxA>1 there will be a third access attempt. Let the users be distributed accordingly to the density function p_{X}^{(i′)}[x], where i =Ti−1. This will guarantee that the third convolution will not result in a spike. Instead the distribution of users will be flatten out over time after the third access attempt event as depicted in FIG. 11.

The value of

$${MaxA}^{′} \approx \frac{MaxA}{T} = \frac{k}{Ti} .$$

It is to be noted that the value of MaxA′ is approximate as the choice of i′ will result in convex bumps as shown in FIG. 11. If instead setting i′=Ti it is possible to obtain concave holes where the bumps are now located.

If MaxA′>1 there will be a fourth retry for RACH access. The same method of spreading the users can be applied by distributing them with the probability density function p_{X}^{(i″)}[x], where i′=(T−1)(Ti−1).

For more access attempts the setting of the parameter i^{(j)} is in accordance with one embodiment defined as:

$${i}^{( j - 1 )} = \{ \begin{matrix}1 & j = 0 ( first ) \\ i & j = 1 ( second ) \\ {( T - 1 )}^{j - 2} ( Ti - 1 ) & j > 1.\end{matrix}$$

In accordance with some embodiments a parameter u can be introduced that specifies if the system should prioritize either to maximize the peak RACH load capacity or to always minimize the access delay. The parameter u is in accordance with one embodiment distributed via the air interface to an MTC device, for example using the BCCH carrier. In accordance with some embodiments the parameter u is pre-programmed in the MTC device. This can be performed by changing the order of how the random waiting times are picked. Thus, in accordance with some embodiments before every RACH attempt the mobile device is configured to choose a random waiting time from some distribution. The UE is in accordance with one embodiment configured to let the “widest” distribution be used first, and thus every subsequent distribution will have a smaller width, or in accordance with another embodiment to let the “narrowest” distribution be used first, and let every subsequent distribution have a larger and larger width.

Let u=1 be to optimize peak capacity. In such a case let the first random wait time be given by the distribution defined by p_{X}^{(i″)}[x], the second wait time be defined by p_{X}^{(i′)}[x] and so forth. This assumes that there are only four access attempts on the RACH and if more attempts are desired use the distribution with the largest spread over time first, the second largest the second time and so forth.

This scheme will introduce a larger average delay for the MTC users/devices but on other hand the entire RACH will not be blocked for periods of time when a large amount of MTC users/devices try to access the system.

If u=0, the MTC device is set to minimize the access delay and the wait time distributions are set as defined by the setting of i^{(j-1)} as defined above. Thus i⁽⁻¹⁾=1 (first attempt) and so forth.

In accordance with some embodiments a parameter r that specifies if the systems MTC users/devices should employ a random delay before making a first access attempt to the RACH is employed. The parameter r is in accordance with one embodiment distributed via the air interface to an MTC device, for example using the BCCH carrier. In accordance with some embodiments the parameter r is pre-programmed in the MTC device. The parameter r is set to specify if the MTC users/devices should employ a random delay before making a first access attempt to the RACH.

Let r=1 denote that MTC users/devices should employ an initial random wait time before trying to access the system. The wait time should in such a case be chosen from the distribution p_{X}^{i,1}[x] as specified above. If there still are collisions the first access retry delay should be picked from the distribution p_{X}^{i,2}[x] and so forth.

If r=0 no initial random wait time is employed.

This optional functionality might as well be combined with the use of parameter u as described above.

In accordance with some embodiments the wait time distribution sequences are selected from other sequences than those specified above. This can e.g. make it possible to further approach the ideal uniform distribution of users in time after j retry attempts to the RACH, or to further balance the average delay between different access attempts. Such distributions can be obtained by selecting a set of sequences with suitable auto- and cross-correlation properties, created using different mathematical constructions like e.g. projective geometries or difference families.

An MTC device is configured to operate in accordance with the parameters (i.e. i, u and r)—and of course possibly also alternative values of the existing parameters T and M (which could e.g. be called T2 and M2). The configuration of the MTC device can be executed in a number of different ways, for example.

The parameters (i, u, r) can be broadcasted in one or more appropriate System Information message(s) on e.g. the BCCH.

The MTC device is pre-configured,

The MTC device is configured via an Over-The-Air method (OTA)

The MTC device is configured using Non Access Stratum (NAS) signaling at registration procedures like Attach to the network, Routing/Location/Tracking Area or Session management procedures like PDP Context Activation

The MTC device is configured via the actual application that uses the device for communication with the cellular network having an API to instruct the MTC device whether to use the new procedure or not and/or the values of the parameters to use.

The MTC device is configured using dedicated signaling over FACCH, SACCH, PACCH or similar

Once an MTC device has become GPRS attached it is activated as an MTC device (e.g. using MTC device-MTC server signaling) which can include configuring it

The MTC device can be hard-coded. The hard-coding can be made in response to specifications as dependent on e.g. which MTC optimization category, QoS or other properties of the MTC device.

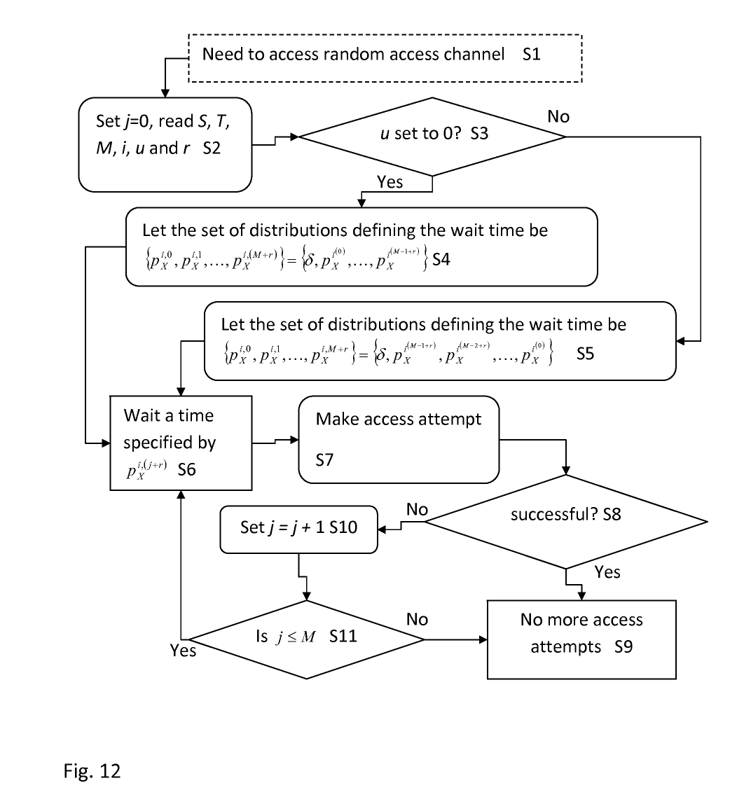

In FIG. 12 a flow chart illustrating an exemplary random access scheme for an MTC device with varying wait time distributions is shown. It is to be noted that in some embodiments one or many of the steps described in FIG. 12 is omitted for example because only a subset of the parameters i, u and r may be used in a particular embodiment. In other embodiments some steps are replaced by other steps including use of other distributions than the distributions used in FIG. 12. First in a step S1 it is determined that an access attempt is to be made. Next in a step S2 the relevant parameters are retrieved. The parameters can e.g. be retrieved via the BCCH. In the example depicted in FIG. 12 it is assumed that the parameters S, T, M, i, u and r as described above are all retrieved and read by the MTC device. Next in a step S3 it is determined if the parameter u is set to zero. If the parameter u is set to zero the procedure continues to a step S4. In Step S4 the set of distributions defining the wait time is set to a first set of distributions that in this embodiment is:

{p_{X}^{i,0}, p_{X}^{i,1}, . . . , p_{X}^{i,(M+r)}}={δ, p_{X}ⁱ^{⁽⁰⁾}, . . . , p_{X}ⁱ^{^{(M−1+r)}}}.

If in Step S3 u is not set to zero the procedure continues to a step S5. In Step S5 the set of distributions defining the wait time is set to a second set of distributions that in this embodiment is:

{p_{X}^{i,0}, p_{X}^{i,1}, . . . , p_{X}^{i,M+r}}={δ, p_{X}ⁱ^{^{(M−1+r)}}, p_{X}ⁱ^{^{(M−2+r)}}, . . . , p_{X}ⁱ^{⁽⁰⁾}}

When the set of distributions has been set in either step S4 or S5 the procedure continues to a step S6. In step S6 the MTC device waits a time specified by p_{X}^{i,(j+r)}, where j corresponds to the number of the attempt with j=0 for the first attempt. Next in a step S7 an access attempt is made. Then in a step S8 it is determined if the attempt was successful. If in step S8 it is determined that the attempt was successful the procedure continues to a step S9. In step S9 the access attempt is finished. If in step S8 it is determined that the attempt was not successful the procedure continues to a step S10. In step S10 the parameter j is increased by one. From step 10 the procedure continues to a step S11. In step S11 it is determined if the parameter j exceeds the parameter M (M being the parameter controlling the maximum number of attempts). If j exceeds M in step S11 the procedure continues to step S9. In step S9 the access attempt is finished. If j does not exceed M in step S11 the procedure returns to step S6 with an increased value of the parameter j as set in step S10.

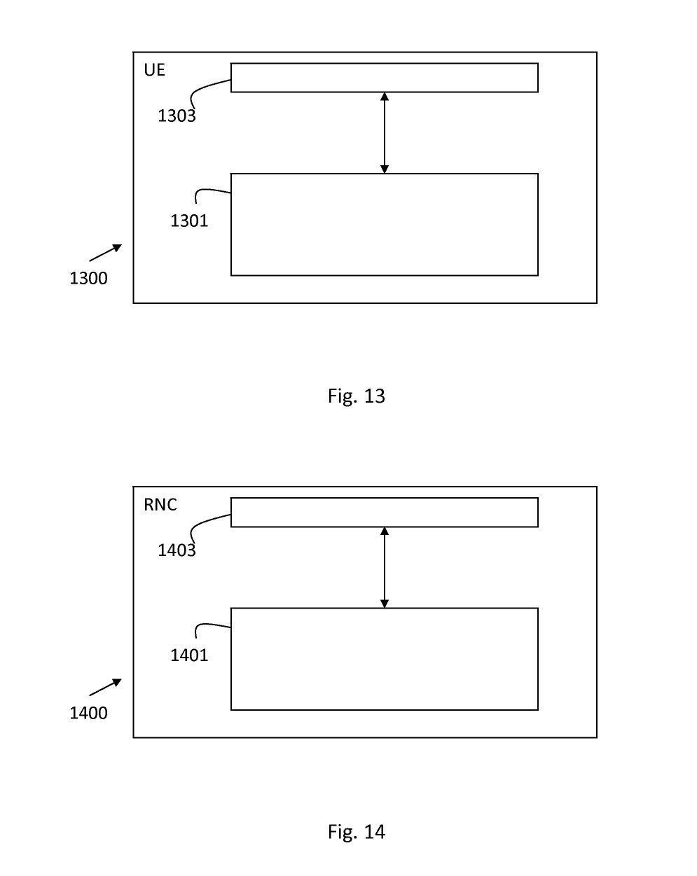

Further in FIG. 13 a UE 1300, in particular an MTC UE, is schematically depicted. The UE 1300 comprises controller circuitry 1301 for performing all the procedures performed by the UE as described herein. The controller circuitry 1301 can be implemented using suitable hardware and or software. The hardware can comprise one or many processors that can be arranged to execute software stored in a readable storage media. The processor(s) can be implemented by a single dedicated processor, by a single shared processor, or by a plurality of individual processors, some of which may be shared or distributed. Moreover, a processor may include, without limitation, digital signal processor (DSP) hardware, ASIC hardware, read only memory (ROM), random access memory (RAM), and/or other storage media. In addition the UE 1300 comprises an input/output device 1303 for receiving/transmitting data to a radio base station.

Further, in FIG. 14 a central node 1400 of a radio system, in particular a cellular radio system is schematically depicted. The central node can for example be a radio network controller or a Base Station Controller or even a radio base station. The central node 1400 comprises controller circuitry 1401 for performing all the procedures performed by the central node on the network side as described herein. The controller circuitry 1401 can be implemented using suitable hardware and or software. The hardware can comprise one or many processors that can be arranged to execute software stored in a readable storage media. The processor(s) can be implemented by a single dedicated processor, by a single shared processor, or by a plurality of individual processors, some of which may be shared or distributed. Moreover, a processor or may include, without limitation, digital signal processor (DSP) hardware, ASIC hardware, read only memory (ROM), random access memory (RAM), and/or other storage media. In addition the central node 1400 comprises an input/output device 1403 for receiving/transmitting data to a UE (via a designated radio base station in the case the central node is not the radio base station).

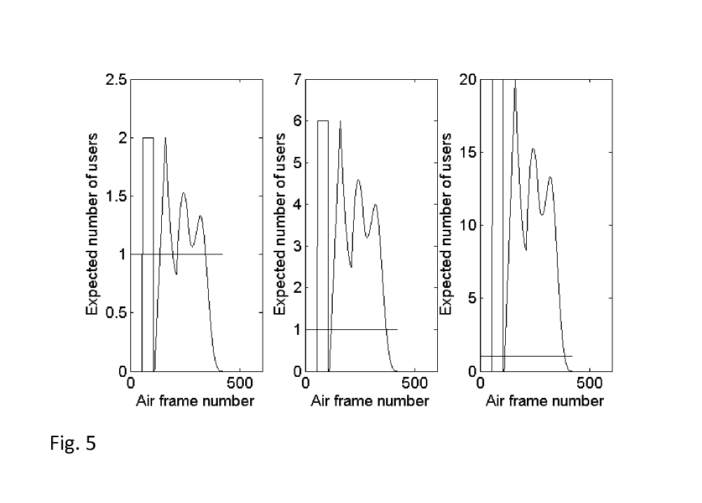

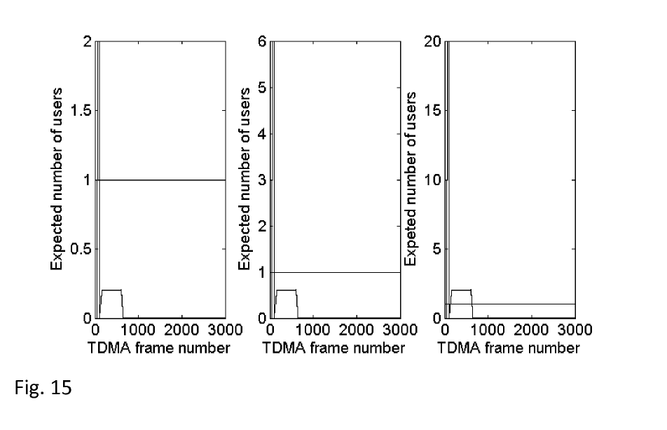

To further illustrate the benefit of the random access procedure as described herein, the same probabilistic behavior over time as shown in FIG. 5 is shown for a procedure in accordance with the teachings herein in FIG. 15. Again for the case when 100, 300 and 1000 users attempt to access the system via the RACH when T=50, S=55 and M=4. FIG. 15 shows the expected number access attempts per RACH slot when performing the first access attempt at air frame number 0. Every time the values in the graph exceeds the value 1 (as marked in FIG. 15) there are in average more than one access attempt per RACH slot, whereupon the RACH and thus the cell will in practice be inaccessible during these instances.

Fig. thus shows the probabilistic behaviour over time for simultaneous access attempts of 100 users (left), 300 users (middle) and 1000 users (right) when T=50, S=55, M=4 and i=10.

Naturally, it takes longer before all users are served, but it is possible to avoid the peaks associated with the aggregated distribution even after the third access attempt. Further, there really is no need for a fourth access attempt with i=10, since that would require some 25000 users arriving exactly simultaneous (with the current parameter setting). For each of the scenarios the following happens:

100 users: All are served on the second access attempt. During the second access attempt they occupy approximately 20% of the RACH slots. Thus the RACH channel is only completely blocked during 0.23 s (access attempt 1).

300 users: All are served on the second access attempt, during the second access attempt they occupy approximately 60% of the RACH slots, Thus the RACH channel is only completely blocked during 0.23 s (access attempt 1) and still has a limited capacity of 40% during an additional 2.5 s.

1000 users: All are served on the third access attempt. During the third attempt they occupy approximately 4% of the resources. Thus there is still 96% of the capacity available. The RACH channel is pretty much completely blocked during 2.73 s (access attempt 1 and 2). The third access attempt takes place during ˜112 s.

What achieved is that it is possible to avoid the extreme peaks and outages of the RACH by employing a random distribution which is spreading the access attempts more for each subsequent access attempt. As pointed out above it is possible to rearrange the order of the distributions, thus greatly increasing the delay of MTC devices but making the impact on the RACH channel for other users minimal.

It is to be noted that the invention is not limited to GERAN, but can be used for any system that has a collision based access channel, such as e.g. any 3GPP or 3GPP2 network, WiFi, etc.

1. A method in a user equipment for accessing a radio network via a collision based access channel, the method comprising, responsive to the failure of an attempt to access the radio network via the collision based access channel, delaying successive attempts to access the radio network via the collision based access channel, determining, for each successive access attempt, a time to delay that attempt by determining, based on a first parameter, a particular spreading of the probability density function of a distribution defined by system parameters.

2. The method according to claim 1, wherein determining, for each successive access attempt, a time to delay that attempt comprises determining a particular wait time distribution for the attempt, wherein the first parameter specifies the wait time distribution as a particular width of the probability density function of said distribution.

3. The method according to claim 1, wherein determining, for each j-th successive access attempt, a time to delay that attempt j comprises determining a random time to delay the attempt j, wherein the random time is a function of the first parameter and the number j, wherein j is a positive integer.

4. The method according to claim 1, wherein determining, for each successive access attempt, a time to delay that attempt comprises determining the time further based on a second parameter that specifies whether the particular spreading of the probability density function of the distribution prioritizes maximization of the peak load capacity of the collision based access channel or prioritizes minimization of access delay.

5. The method according to claim 1, determining, for each successive access attempt, a time to delay that attempt comprises determining the time further based on a third parameter that specifies whether or not the user equipment is to employ a delay before making a first access attempt via the collision based access channel.

6. The method according to claim 1, wherein the user equipment is a Machine Type Communication device.

7. The method according to claim 1, wherein the collision based access channel is a random access channel.

8. A user equipment configured to access a radio network via a collision based access channel, the user equipment comprising controller circuitry configured, responsive to the failure of an attempt to access the radio network via the collision based access channel, delay successive attempts to access the radio network via the collision based access channel, and to determine, for each successive access attempt, a time to delay that attempt by determining, based on a first parameter, a particular spreading of the probability density function of a distribution defined by system parameters.

9. The user equipment according to claim 8, wherein the controller circuitry is configured to determine, for each successive access attempt, a time to delay that attempt by determining a particular wait time distribution for the attempt, wherein the first parameter specifies the wait time distribution as a particular width of the probability density function of said distribution.

10. The user equipment according to claim 8, wherein the controller circuitry is configured to determine, for each j-th successive access attempt, a time to delay that attempt j by determining a random time to delay the attempt j, wherein the random time is a function of the first parameter and the number j, wherein j is a positive integer.

11. The user equipment according to claim 8, wherein the controller circuitry is configured to determine, for each successive access attempt, a time to delay that attempt by determining the time further based on a second parameter that specifies whether the particular spreading of the probability density function of the distribution prioritizes maximization of the peak load capacity of the collision based access channel or prioritizes minimization of access delay.

12. The user equipment according to claim 8, wherein the controller circuitry is configured to determine, for each successive access attempt, a time to delay that attempt by determining the time further based on a third parameter that specifies whether or not the user equipment is to employ a delay before making a first access attempt via the collision based access channel.

13. The user equipment according to claim 8, wherein the user equipment is a Machine Type Communication device.

14. The user equipment according to claim 8, wherein the collision based access channel is a random access channel.

15. A method in a central node of a radio network for configuring a user equipment to access the radio network via a collision based access channel, wherein the user equipment is configured, responsive to the failure of an attempt to access the radio network via the collision based access channel, to delay successive attempts to access the radio network via the collision based access channel, wherein the method comprises distributing to the user equipment a first parameter that controls the time for which the user equipment delays each successive access attempt, the first parameter controlling, for each successive access attempt, a particular spreading of a probability distribution function of a distribution defined by system parameters.

16. The method according to claim 15, wherein the first parameter controls the time for which the user equipment delays each successive access attempt by specifying a particular wait time distribution for the attempt, wherein the first parameter specifies the wait time distribution as a particular width of the probability density function of said distribution.

17. The method according to claim 15, further comprising distributing to the user equipment a second parameter that specifies, for each successive access attempt, whether the particular spreading of the probability density function of the distribution prioritizes maximization of the peak load capacity of the collision based access channel or prioritizes minimization of access delay.

18. The method according to claim 15, further comprising distributing to the user equipment a third parameter that specifies whether or not the user equipment is to employ a delay before making a first access attempt via the collision based access channel.

19. The method according to claim 15, wherein the central node is a radio base station or a radio network controller.

20. The method according to claim 15, wherein the collision based access channel is a random access channel.

21. A central node of a radio network adapted to configure a user equipment to access the radio network via a collision based access channel, wherein the user equipment is configured, responsive to the failure of an attempt to access the radio network via the collision based access channel, to delay successive attempts to access the radio network via the collision based access channel, and wherein the central node comprises controller circuitry configured to distribute to the user equipment a first parameter that controls the time for which the user equipment delays each successive access attempt, the first parameter controlling, for each successive access attempt, a particular spreading of a probability distribution function of a distribution defined by system parameters.

22. The central node according to claim 21, wherein the first parameter controls the time for which the user equipment delays each successive access attempt by specifying a particular wait time distribution for the attempt, wherein the first parameter specifies the wait time distribution as a particular width of the probability density function of said distribution.

23. The central node according to claim 21, wherein the controller circuitry is further configured to distribute to the user equipment a second parameter that specifies, for each successive access attempt, whether the particular spreading of the probability density function of the distribution prioritizes maximization of the peak load capacity of the collision based access channel or prioritizes minimization of access delay.

24. The central node according to claim 21, wherein the controller circuitry is further configured to the user equipment a third parameter that specifies whether or not the user equipment is to employ a delay before making a first access attempt via the collision based access channel.

25. The central node according to claim 21, wherein the central node is a radio base station or a radio network controller.

26. The central node according to claim 21, wherein the collision based access channel is a random access channel.
